(19) United States
(12) Patent Application Publication
(10) Pub. No.: US 2024/0329718 A1
(43) Pub. Date: Oct. 3, 2024

(54) REDUCED POWER CONSUMPTION CIRCUIT AND CORRESPONDING METHOD

(71) Applicant: STMICROELECTRONICS INTERNATIONAL N.V., Geneva (CH)

(72) Inventors: Antonino MONDELLO, Messina (IT); Alessandro INGLESE, San Pietro Clarenza (IT); Riccardo CONDORELLI, Tremestieri Etneo (IT)

(21) Appl. No.: 18/606,928

(22) Filed: Mar. 15, 2024

(30) Foreign Application Priority Data
Mar. 31, 2023 (IT) 102023000006282

(51) Int. Cl. G06F 1/324

(52) U.S. Cl. CPC G06F 1/324

(57) ABSTRACT

A system on chip, SOC circuit comprising a plurality of peripherals configured to be clocked with respective clock signals, wherein the circuit comprises a clock controller configured to produce said respective clock signals via respective clock divide factors, the clock controller comprising a plurality of storage locations having stored therein respective sets of clock divide factors, wherein the clock controller comprises clock divide factor selection circuitry configured to select an operating set of clock divide factors out of said respective sets of clock divide factors stored in said plurality of storage locations and wherein the clock controller is configured to apply to the plurality of peripherals respective clock signals produced via the clock divide factors in the operating set of clock divide factors selected out of said respective sets of clock divide factors stored in said plurality of storage locations.

### CROSS REFERENCE TO RELATED APPLICATIONS

This application claims the priority benefit of Italian patent application number 102023000006282, filed on Mar. 31, 2023, entitled “CIRCUITO CON ASSORBIMENTO DI POTENZA RIDOTTO E PROCEDIMENTO CORRISPONDENTE,” which is hereby incorporated by reference to the maximum extent allowable by law.

### TECHNICAL FIELD

The description relates to electronic circuits.

One or more embodiments can be applied to electronic circuits such as, for instance, System On Chip, SOC circuits with power-saving features.

### BACKGROUND

Certain electronic devices such as portable devices like cellular phones are unable to support prolonged high power consumption conditions due to battery limitations.

A control of power absorption and performance may effectively counter waste of energy and at the same time improve performance under energy constraints.

A dynamic balance of power absorption and performance, possibly detecting unnecessary/undesired extra power consumption and facilitating low power consumption (whenever this does not result in undesired performance degradation) may thus represent a goal to pursue in these applications.

Solutions with balanced current consumption and performance, especially with applications unable to support high current consumption for a long time, due to battery limitations, for instance, are thus desirable.

### BRIEF SUMMARY

An object of one or more embodiments is to contribute in providing such a solution.

According to one or more embodiments, that object is achieved via a circuit (a system on chip, SOC circuit, for instance) having the features set forth in the claims that follow.

One or more embodiments concern a related configuration method.

The claims are an integral part of the technical teaching provided in respect of the embodiments.

Solutions as described herein include a consumption detector, CD and a clock controller, CC with a set of clock division factors applied to control consumption.

For instance, in exemplary solutions as described herein, a consumption detector, CD uses two threshold registers to save two current values Imax1_{reg} and Imax2_{reg}; these represent an upper threshold and a lower threshold, respectively, that can be set according to battery specifications. A current absorbed is compared with these two thresholds and, based on the result of comparison with these thresholds Imax1_{reg} and Imax2_{reg}, a set of parameters (dividers of the clocks) is selected and applied.

In exemplary solutions as described herein:
division factors can be calculated by a clock controller, SCC, contained within the clock controller, CC, in order to reduce consumption by reducing an operating frequency by modifying the clocks, and
the clock controller, SCC may implement a learning procedure to determine certain sets of clock division factors, for instance, with the possibility of applying fixed clock dividers for certain functions held to be critical.

Solutions as described herein facilitate achieving a judicious trade-off between current consumption and performance.

### BRIEF DESCRIPTION OF THE DRAWINGS

One or more embodiments will now be described, by way of example only, with reference to the annexed figures, wherein:

FIG. 1 is a block diagram of a regulated supply domain in System On Chip, SOC architecture;

FIG. 2 is a block diagram of a clock controller and peripherals coupled therewith;

FIG. 3 is a block diagram of a regulated supply domain in System On Chip architecture according to embodiments of the present disclosure;

FIG. 4A and FIG. 4B are block diagrams of a consumption detector according to embodiments of the present disclosure;

FIG. 5 is a block diagram of a clock controller and associated peripherals according to embodiments of the present disclosure; and

FIG. 6 is a block diagram of a clock controller according to embodiments of the present disclosure.

Corresponding numerals and symbols in the different figures generally refer to corresponding parts unless otherwise indicated.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION

In the ensuing description one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment.

Moreover, particular configurations, structures, or characteristics may be combined in any adequate way in one or more embodiments.

The headings/references used herein are provided merely for convenience and hence do not define the extent of protection or the scope of the embodiments.

For simplicity and ease of explanation, throughout this description, and unless the context indicates otherwise, like parts or elements are indicated in the various figures with like reference signs, and a corresponding description will not be repeated for each and every figure.

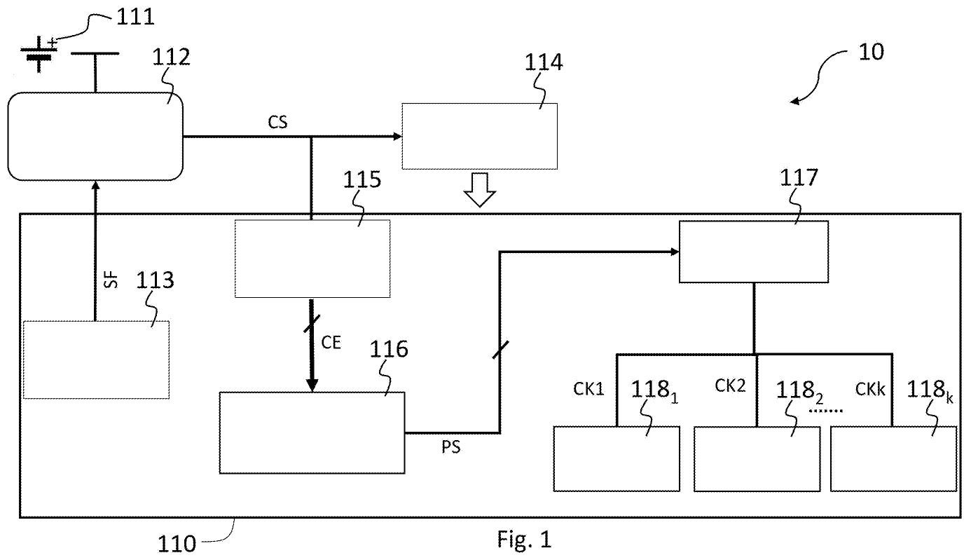

FIG. 1 discloses a regulated supply domain, RSD 110 of System On Chip, SOC architecture 10, that does not include a feature for achieving control of power absorption and performance, which may result in faster battery depletion and reduced performance.

The SOC architecture 10 and of the regulated supply domain 110 are powered via a voltage supply 111 (i.e., a battery, for instance, a coin battery at a voltage VS), which is coupled to a power management unit (PMU) 112.

The power management unit 112 is powered by the battery 111 and is configured to receive a supply feedback signal SF from a power grid 113 and to output a current control signal CS to a regulator 114.

The regulator 114 is configured to regulate the voltage of the regulated supply domain 110, and the current control signal CS is also applied to a consumption detector 115.

The consumption detector CD 115 is configured to monitor the amount of current in the RSD 110 and to provide a current evaluation signal CE to a power control logic unit 116.

The power control logic unit 116 is configured to receive the current evaluation signal CE as an input and to output, based on the state of the signal CE, a power status signal PS (for instance, run, low power run, standby, etc.) that is then provided to a clock controller, CC 117.

The clock controller, CC 117 is configured to generate, according to the input power status signal PS received from the power control logic unit 116, a plurality of different clock signals CK1, CK2, . . . , CKk that are provided to a plurality of (peripheral) clock domains 118₁, 118₂, . . . , 118ₖ.

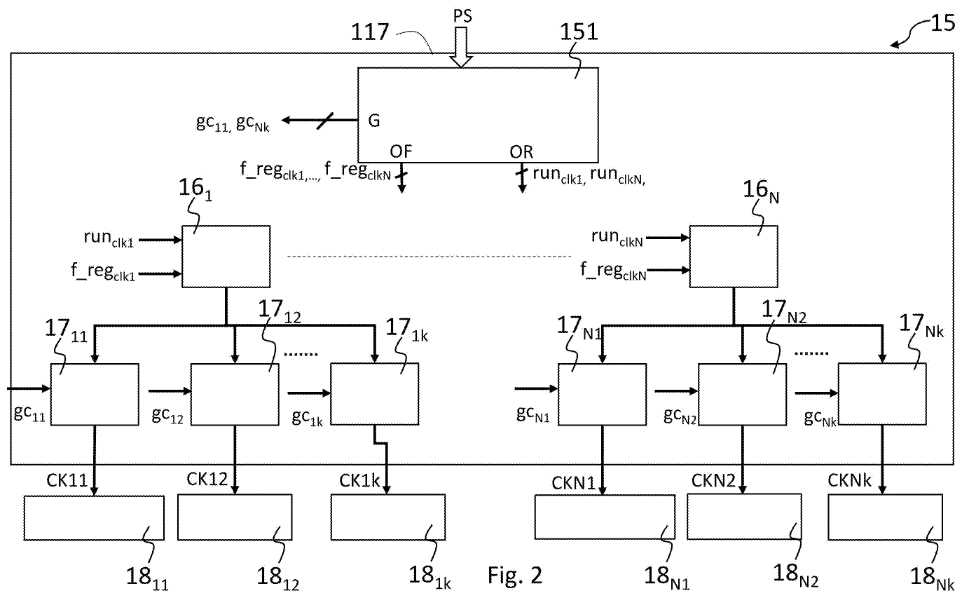

FIG. 2 shows a possible implementation of a clock controller 117 as illustrated in FIG. 1 having coupled therewith a plurality of peripherals 18₁₁, 18₁₂, . . . , 18₁ₖ to 18_{N1}, 18_{N2}, . . . , 18_{Nk}.

These peripherals may be in any number and include, by way of example, master or slave peripherals that may be managed by standard/custom buses, for instance, AHB (Advanced High-performance Bus), APB (“Advanced Peripheral Bus”), or any others (OBI “Open Bus Interface”, AXI “Advanced extensible Interface”, etc.).

The clock controller 117 is configured to receive from the power control logic unit 116 a power status signal PS (see the diagram of FIG. 1) and to apply that signal PS to a clock controller logic and register block 151 included in the clock controller 117.

The clock controller 117 illustrated in FIG. 2 does not provide for absorption control, which may lead to fast battery depletion and reduced performance.

As illustrated In FIG. 2, the block 151 is configured to calculate and provide as its outputs:
oscillator frequencies f_reg_{clk1}, . . . , f_reg_{clkN} (collectively designated OF);
oscillator run values run_{clk1}, . . . , run_{clkN} (collectively designated OR), and

gating values gc₁₁, . . . , gC_{Nk} (collectively designated G).

The oscillator frequencies OF and the oscillator n values OR are provided as input to respective oscillators labelled 16₁, . . . , 16_{N}. Each oscillator 16₁, . . . , 16_{N} generates a different clock signal for different clock domains 118₁, 118₂, . . . , 118ₖ. The oscillators 16₁, . . . , 16_{N} are configured to generate the respective clock signals according to the (respective) oscillator frequency f_reg_{clk1}, . . . , f_reg_{clkN} and run run_{clk1}, . . . , run_{clkN} values received.
a. The oscillators 16₁, . . . , 16_{N} are configured to provide their respective generated clock signals to respective sets of gating blocks 17₁₁, 17₁₂, . . . , 17₁ₖ to 17_{N1}, 17_{N2}, . . . , 17_{Nk}.

The sets of gating blocks 17₁₁, 17₁₂, . . . , 17₁ₖ to 17_{N1}, 17_{N2}, . . . , 17_{Nk} are configured to be clocked by the clock signals generated by the respective oscillators 16₁, . . . , 16_{N} and receive the gating values gc₁₁, . . . , gC_{Nk} provided by the clock controller logic and registers block 151, to output respective sets of gated clock signals CK11, CK12, . . . , CK1k to CKN1, CKN2, . . . , CK1M to the peripherals 18₁₁, 18₁₂, . . . , 18₁ₖ to 18_{N1}, 18_{N2}, . . . , 18_{Nk} respectively coupled therewith.

As discussed, various embodiments of the present disclosure provide solutions for a regulated supply domain of System On Chip architecture with a power saving feature: for a general description of a regulated supply domain in conventional System On Chip architecture, reference can be made to the previous description of FIGS. 1 and 2.

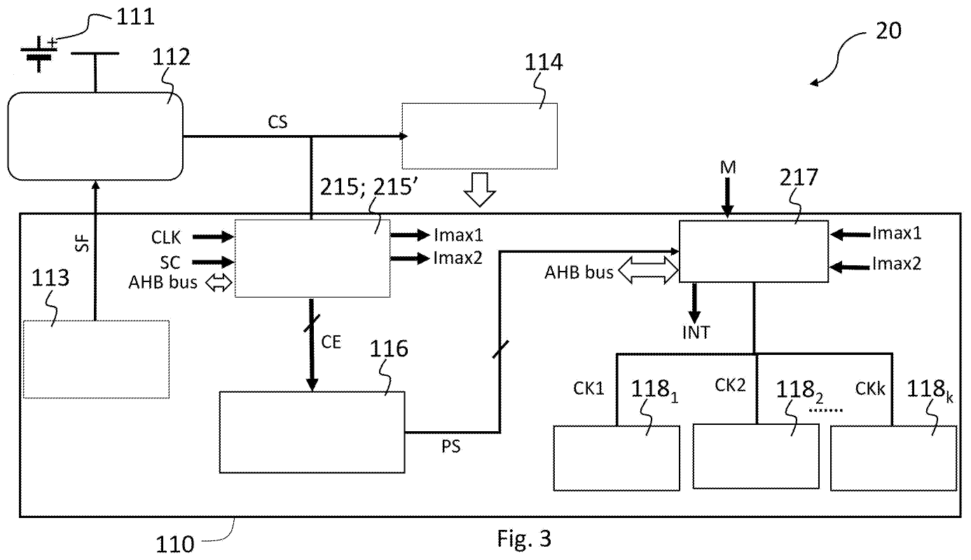

FIG. 3 is a block diagram showing a regulated supply domain 20 in System On Chip architecture according embodiment of the present disclosure.

For brevity and ease of understanding, in FIGS. 3 to 6 parts or elements like parts or elements already described in connection with FIGS. 1 and 2 are denoted by the same reference symbols already appearing in FIGS. 1 and 2 and a detailed description of these parts or elements will not be repeated in the following.

By way of direct comparison with FIG. 1, the regulated supply domain 20 illustrated in FIG. 3 includes, together with parts or elements that may be unchanged with respect to FIG. 1:

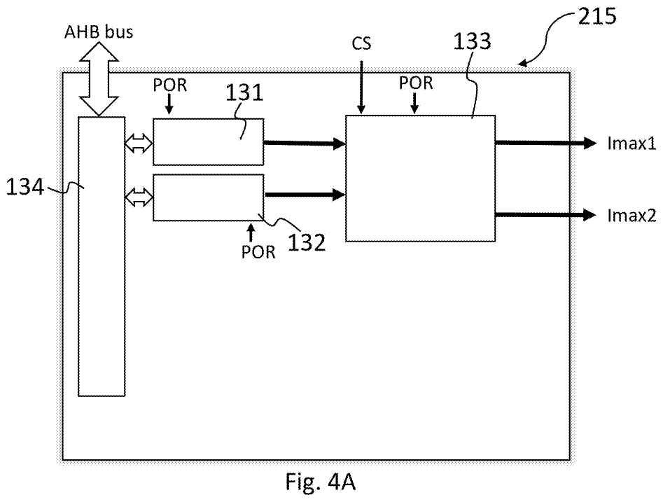

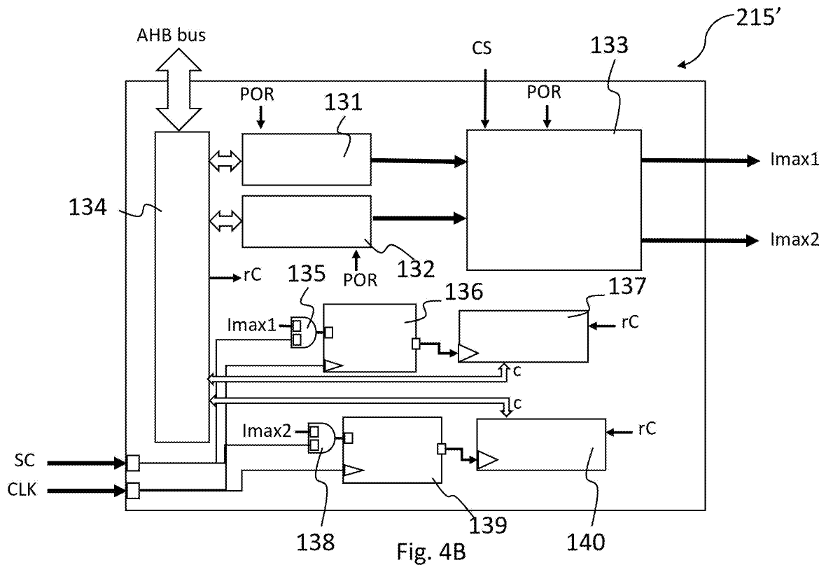

a consumption detector, CD—this may be, for instance, either the consumption detector 215 of FIG. 4A or the consumption detector 215′ of FIG. 4B—that is configured to replace the consumption detector 115 of FIG. 1, and
a clock controller, CC 217 that is configured to replace the clock controller 117 of FIG. 1.

As illustrated in FIGS. 3, 4A, and 4B the consumption detector CD 215, 215′ receives as input values the current control signal CS, a clock signal CLK, and a count start flag SC: for instance, this may be via an Advanced High-performance, AHB bus and the representation of the AHB as a separate entity in FIG. 3 is merely functional and for the sake of clarity.

As illustrated in FIGS. 3, 4A, and 4B: the consumption detector CD 215, 215′ is
configured to provide as outputs the current evaluation signal CE, a first flag Imax1, and a second flag Imax2; and
the clock controller CC 217 is configured to be coupled to the AHB bus and to receive as input values the first flag Imax1, the second flag Imax2, a power status signal PS, and a mode signal M. In addition, it is configured to provide as outputs such plurality of different clock signals CK1, CK2, . . . , CKk and, optionally, an interrupt INT which may be maskable to core.

FIGS. 4A and 4B are block diagrams showing certain features of a consumption detector CD 215, 215′ according to embodiments of the present disclosure.

For simplicity, features left unchanged with respect to FIG. 1 are not visible in FIGS. 4A and 4B.

The consumption detector CD 215 of FIG. 4A includes two threshold registers, 131 and 132, which are configured to have stored therein the values for two thresholds, a first threshold Imax1_{reg} and a second threshold Imax2_{reg}, respectively. These are an upper threshold and a lower threshold, respectively, that may be set according to battery specification or introduced by the user, for instance, to be sure that a specific task uses current values that do not reach threshold values determined by the user, for instance, in case of particular applications.

The threshold registers 131, may 132 be accessible, for instance, for both read and write operations, through a standard bus interface 134, for instance, an AHB bus or a different standard bus, and may be configured to receive a POR (“Power-On Reset”) signal to reset the value contained in the threshold registers 131, 132 when a reset event occurs.

The threshold registers 131, 132 are coupled with a current detector block 133 that is configured to receive as input values such first threshold Imax1_{reg} and second threshold Imax2_{reg} stored in the threshold registers 131, 132, the current control signal CS, and the POR signal.

As illustrated, the current detector block 133 is configured to compare a currently available current I, obtained from the current control signal CS, with the first threshold Imax1_{reg} and the second threshold Imax2_{reg} received as input.

For instance, the current detector block 133 may be configured to:
compare the value of the currently available current I with the first threshold Imax1_{reg} and if the condition 1≥Imax1_{reg} is satisfied, the value of a first flag Imax1 is set to 1, otherwise it is set to 0; and
compare the value of the currently available current I with the second threshold Imax2_{reg} and if the condition 1≥ Imax2_{reg} is satisfied, the value of a second flag Imax2 is set to 1, otherwise it is set to 0.

Thus, the first flag Imax1 and second flag Imax2 indicate if the currently available current I, i.e., the current consumption, is over a threshold, for instance, over the first threshold Imax1_{reg} and (also) over the second threshold Imax2_{reg}, respectively.

Hence, the current detector block 133 can be configured to provide as its outputs the value of the first flag Imax1 and the value of the second flag Imax2 continuously. These outputs are then forwarded as outputs of the consumption detector CD 215.

FIG. 4B is a block diagram showing a consumption detector CD 215′ according to another embodiment of the present disclosure. In addition to the components already described in FIG. 4A (these will not be described again in the following in order not to overburden the present detailed description) the consumption detector CD 215′ of FIG. 4B may optionally contain two counter registers, 137 and 140, that are configured to contain the values of two counters, a first counter CImax1_{reg} and a second counter CImax2_{reg}, respectively.

The first counter CImax1_{reg}, when enabled, is configured to count the number of clock periods in which the condition I≥Imax1_{reg} is satisfied, while the second counter CImax2_{reg}, when enabled, is configured to count the number of clock periods in which the condition I≥Imax2_{reg} is satisfied.

The counter registers 137, 140 may be accessible, for instance, for both read and write operations, through a standard bus interface 134, for instance, the AHB bus or a different standard bus, and they may be configured to receive a reset signal rC from the bus interface 134 to reset the value contained in the counter registers 137, 140. The consumption detector, CD 215′ is further configured to receive the clock signal CLK and the count start flag SC as input signals.

The count start flag SC is coupled with AND logic gates 135, and 138 and it is used to enable the count of the conditions I≥Imax1_{reg}, and I≥Imax2_{reg}, respectively.

The AND gate 135 is configured to receive at its inputs the first flag Imax1 and, as previously described, the count start flag SC which is used as a masking signal for the first flag Imax1.

The output of the AND gate 135 is set in response to both the first flag Imax1 and the count start flag SC being set, and is provided as input to a clock gating block 136.

As illustrated, the clock gating block 136 is configured to receive as input the output of the AND gate 135 and the clock signal CLK, and provides as output a gated clock that is used to drive the counter register 137.

Similarly, the output of the AND gate 138 is set in response to both the second flag Imax2 and the count start flag SC being set, and is provided as input to a clock gating block 139.

The clock gating block 139 is configured to receive as input the output of the AND gate 138 and the clock signal CLK, and provides as output a gated clock that is used to drive the counter register 140.

The circuitry that differentiates the embodiment of FIG. 4B from the embodiment of FIG. 4A provide for the possibility of having an insight of the effective number of times in which the first and second flags Imax1 and Imax2 are set.

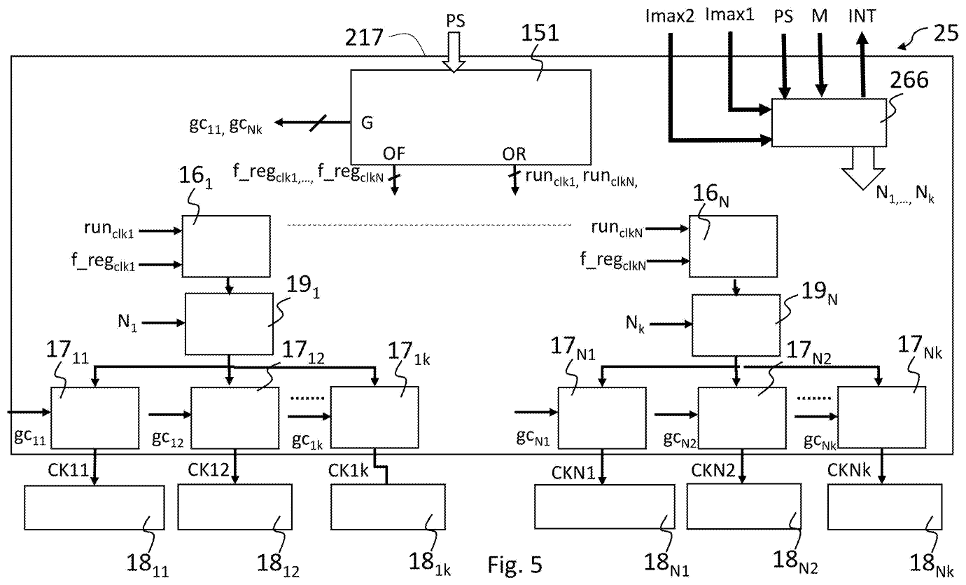

FIG. 5 is a block diagram showing a clock controller 25 and peripherals 18₁₁, 18₁₂, . . . , 18₁ₖ to 18_{N1}, 18_{N2}, . . . , 18_{Nk}, coupled therewith. According to various possible embodiments of the present disclosure these may be, for instance, master or slave peripherals such as AHB (“Advanced High-performance Bus”) or APB (“Advanced Peripheral Bus”) peripherals.

In the following, elements or components which have already been described with reference to the previous figures are denoted by the same references previously used in these figures. A description of these elements already described previously will not be repeated in order not to overburden the present detailed description.

The solutions described herein include a clock controller, CC 217 with a set of clock division factors calculated by a clock controller SCC to be then applied to modify peripheral consumption, reducing the operating frequencies of the peripherals by modifying the clocks applied thereto, which leads to a more accurate control of power consumption and performance.

In the embodiment illustrated in FIG. 5, the oscillators 16₁, . . . , 16_{N} are configured to generate respective clock signals according to a respective received oscillator frequency and a respective run value.

In the embodiment illustrated in FIG. 5, the oscillators 16₁, . . . , 16_{N} are configured to provide the respective generated clock signal to an intermediate clock divider block 19₁, . . . , 19_{N}.

The intermediate clock divider block 19₁, . . . , 19_{N} is configured to receive as inputs the respective clock signals and clock divide factors N₁, . . . , Nₖ, and is configured to provide as an output a divided clock signal which is then provided to respective sets of gating blocks 17₁₁, 17₁₂, . . . , 17₁ₖ to 17_{N1}, 17_{N2}, . . . , 17_{Nk}.

As illustrated herein, the clock divide factors N₁, . . . , Nₖ, are computed in a circuit 266 taking into account clock constraints and then stored in dedicated registers associated therewith.

The circuit 266 is configured to act as a “smart” clock controller SCC and will be referred to in the following either as SCC or, briefly, as clock controller.

A non-limiting example of a clock constraints that can be taken into account in computing clock division factors N₁, . . . , Nₖ is, for instance, α₁f_{clk1}>α₂f_{clk2}, etc. wherein some of the ax factors may be rational αₓ=pₓ/qₓ.

Moreover, a configuration of the clock division factors N₁, . . . , Nₖ such as N₁=0, . . . , Nₖ=0 may be regarded as inadmissible.

In a default configuration of the clock division factors N₁, . . . , Nₖ, the value associated with such clock division factors N₁, . . . , Nₖ is N₁=1, . . . , Nₖ=1 which is called the “legacy condition”. In the legacy condition, the method cannot change the original clock phases and the clock gating policy.

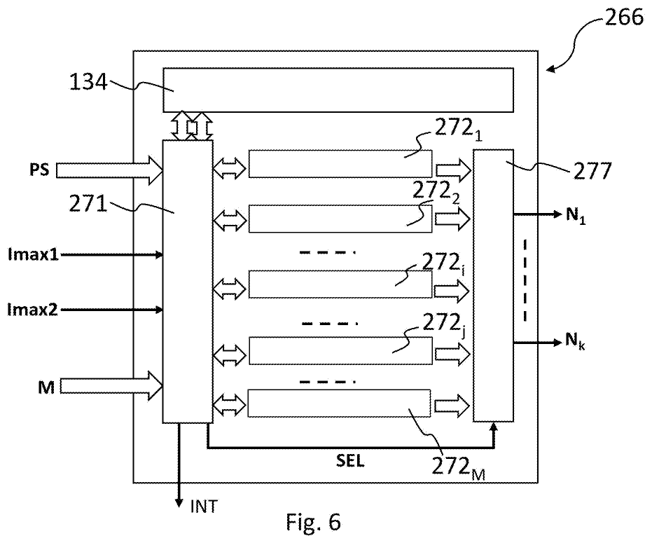

As illustrated in FIG. 6, the clock controller circuit 266 (SCC) is configured to receive as inputs the first flag Imax1, the second flag Imax2, the power status signal PS, and the mode signal M, and is configured to provide as its output an interrupt INT which may be maskable to core and the set of such clock divide factors N₁, . . . , Nₖ.

In addition, the clock controller 266 may implement a method to determine certain sets of clock division factors, for instance, with the possibility to applying fixed clock dividers for certain functions held to be critical.

FIG. 6 is a block diagram of a “smart” clock controller 266 according to embodiments of the present disclosure.

As previously stated, the clock controller 266 is configured to be coupled to the bus interface 134, for instance, an Advanced High-performance Bus (AHB), Open Bus Interface (OBI), Advanced extensible Interface (AXI), or other types of standard interfaces, and to receive at its inputs:
the first flag Imax1 and the second flag Imax2, which are provided by the consumption detector CD 215, and that indicate over threshold events,
the power status signal PS, for instance, run, low power run, standby, etc., received from the power control logic unit 116; and
the mode M, for instance, transparent, set/reset, active, forced, etc.

As illustrated, the clock controller 266 is configured to provide as an output:
the interrupt INT, whenever the first flag Imax1 and/or the second flag Imax2 are set, which is sent to a core and that may be maskable to such core; and
the set of clock divide factors N₁, . . . , Nₖ that are currently in use, i.e., corresponding to the current mode M in use.

The input signals received by the clock controller SCC 266 are forwarded as inputs to a control register 271. The control register 271 is coupled to the bus interface 134 which is used, for instance, by a core, to configure such control register 271, for instance, to read/write sets of registers.

The control register 271 is further coupled to sets of registers RS 272₁, . . . , 272₂, 272₁, . . . , 272ⱼ, . . . , 272_{M} each of them containing the values of the clock divide factors N₁, . . . , Nₖ to be used for each different power scenario plus some others used for special purposes.

Exemplary possible sets of registers may include:
a set RS₁ 272₁, which contains (in k positions) clock divide factors (N₁, . . . , Nₖ)₁ for use in a run mode;
a set RS₂ 272₂, which contains (in k positions) clock divide factors (N₁, . . . , Nₖ)₂ for use in a low-power run mode;
sets RS₁ 272ᵢ to 272ⱼ, which contain (in k positions) clock divide factors (N₁, . . . , Nₖ)ᵢ to (N₁, . . . , Nₖ)ⱼ for use in running various subtasks; and
a set RS_{M} 272_{M}, for instance, learning registers, which contain (in k positions) clock divide factors (N₁, . . . , Nₖ)_{M} for use in a learning mode.

The registers in the sets of registers exemplified above, collectively referred to as 272 in the following, are coupled to inputs of a multiplexer 277.

As illustrated, the control register 271 is configured to manage the selection of registers in the sets collectively referred to as 272 based on the received input mode signal M.

As illustrated, the control register 271 generates a selection signal SEL which is forwarded to the multiplexer 277 to select the multiplexer inputs, namely, the set of registers, for instance, 272₁, to be used and that can be coupled with the output of the multiplexer.

The output from the multiplexer 277 is provided as an output from the (“smart”) clock controller 266 which identifies the set of clock divide factors N₁, . . . , Nₖ related to the currently used power mode M.

In addition, the control register 271 can also generate an interrupt INT, which is then forwarded to the clock controller SCC 266.

The input mode signal M may have, by way of example, one of the following contents/meanings:
transparent, namely a default state where the clock division factors N₁, . . . , Nₖ are equal to those of the “legacy condition”, for instance N₁=1, . . . , Nₖ=1;
set/reset, namely a condition where the content of the sets of registers can be modified, for instance, from the AHB bus, with learning registers copied in one set of registers in the sets of registers;
active, namely a condition where the set of registers to be used is selected automatically according to the current power status signal PS from the power control logic unit 116;
forced, namely a condition where the set of registers to be used is imposed by the core, by using the bus interface, for instance, when it is desired to select a set of registers that contains clock divide factors to be used during the run of a specific subtask; and
learning, which can be programmed in a plurality of different ways, according to the method used for the computation of the clock divide factors.

The mode signal M to the clock controller 266 can be set to a forced mode and used to optimize the configuration in use and to optimize power and performance in “special operation” conditions.

In that case, a forced mode is selected (via a system core, for instance) before or during the “special operation” conditions or, alternatively, designer/architect can select the forced mode with special hardware configurations, for instance, when the core is off for low power mode.

Non-limiting examples of “special operation” may be:
a run operation while receiving/transmitting data from/to a radio interface, for instance, a UWB (Ultra-Wide Band) modem, when it is desired that operation consumption should be maintained below a given threshold;
a run operation while a crypt/decrypt operation is in progress, for instance, with both the crypto hardware and the core running;
a low-power run operation while the radio interface, for instance, a UWB modem, is off and a wired interface(s) is/are receiving some data.

In addition, a forced mode can be selected even when an interrupt INT is raised due to overconsumption, for instance, or due to a rare/unexpected event occurring such as low power or performance emergency, i.e., battery level is very low.

The system core refer to herein can also be configured to store the calculated values of the clock divide factors N₁, . . . , Nₖ in a non-volatile memory associated with the core, for instance, a Flash, PCM (“Phase-change memory”), or OTP (“One Time Programmable”), etc. memory.

Then, at each power cycle reset event POR, the calculated values of the clock divide factors N₁, . . . , Nₖ stored within the sets of registers RS 272 are preset to the “legacy condition”, i.e., N₁, . . . , Nₖ is N₁=1, . . . , Nₖ=1.

Once a power on reset (POR) sequence is completed, the core may load the sets of registers RS 272 with non-volatile values for the clock divide factors N₁, . . . , Nₖ previously stored in the non-volatile memory by the core.

Different tuning criteria can be used in order to tune in an efficient way the clock divide factors N₁, . . . , Nₖ.

In the following, certain non-limiting examples of tuning criteria that can be used will be described by way of example.

A possible tuning criterion is a trial-and-error approach that can be implemented on a “one time” basis, once system architecture is devised.

Therefore, once the clock divide factors N₁, . . . , Nₖ are calculated in a first testing phase of the system architecture, the calculated clock divide factors N₁, . . . , Nₖ may be also applied to the whole, or a part of, production of the same system architecture. In addition, the calculated clock divide factors N₁, . . . , Nₖ may be also applied as default value to the products with the same system architecture to be further refined by the users according to their particular needs and applications implemented.

In such a case, multiple “experiments” are performed increasing one-by-one the values of the clock divide factors N₁, . . . , Nₖ, and storing, for each of the attempts, a value for the first counter CImax1_{reg}, a value for the second counter CImax2_{reg}, and the execution time.

In that way, after a set of experiments, it is possible to select combinations of clock divide factors N₁, . . . , Nₖ values that lead to reduced count values for the first and the second counter CImax1_{reg} and CImax2_{reg}, while leaving the execution time involved substantially unchanged.

Exemplary steps that can may be considered for implementing such a tuning criterion are the following:
first step: the input mode signal M is set to a “learning” mode and the learning registers in the set 272_{M} are set to the “legacy condition”, i.e., N₁, . . . , Nₖ is N₁=1, . . . , Nₖ=1;
second step: the values of the two counter registers 137, 140 of the consumption detector 215′ are reset by setting the values of the first counter CImax1_{reg} and of the second counter CImax2_{reg} to a predetermined value, for instance, zero, by using the bus interface 134 (for instance, a AHB interface);
third step: the SOC device 20 is configured to operate in a desired scenario and “optimized” by selecting a specific power mode, that is setting the power status signal PS, for instance, to run, low power run, standby, ecc. thus, preparing the SOC device 20 to execute one or more desired tasks;
fourth step: these tasks are executed on the SOC device; and
fifth step: the values stored in the two counter registers CImax1_{reg} and CImax2_{reg} and the execution time at the end of execution of the one or more tasks are analyzed.

If consumption and performance meet desired specifications, the calculated clock divide factors N₁, . . . , Nₖ stored within the learning registers set RS_{M} 272_{M} are copied to the set of registers of the sets of registers corresponding to the power status signal PS that is currently used, i.e., the used power mode, and the procedure for the computation of the clock divide factors N₁, . . . , Nₖ values stops.

Alternatively, the trial-and-error approach procedure continues until the target consumption and performance are reached via additional steps including:
sixth step: changing the value of the clock divide factors N₁, . . . , Nₖ in the learning registers set 272_{M}, (taking into account possible clock constraints), for instance, incrementing one of the clock divide factors N₁, . . . , Nₖ by 1; and
seventh step: running again the procedure starting from the second step.

This approach results in a simple, yet long (quasi-manual) approach which can be useful for certain purposes.

An example of a second tuning criterion is an automatic approach.

In that case, tuning of the clock divide factors N₁, . . . , Nₖ values may be done directly by the SOC core via different approaches, for instance, simulated annealing, tabu search, etc.

A problem to be solved can be defined as finding optimal clock divide factors N₁ₒₚₜ, . . . , Nₖₒₚₜ:

$$R {S}_{i} = ( {N}_{1 opt} , … , {N}_{kopt} )$$

such that power absorption is minimized and performance maximized taking into account clock constraints.

Hence, optimal clock divide factors N₁ₒₚₜ, . . . . Nₖₒₚₜ can be found by solving an optimization problem and saving the resulting optimal clock divide factors N₁ₒₚₜ, . . . , Nₖₒₚₜ in a set of registers out of the sets of registers corresponding to the power mode used, that is to the power status signal PS.

Such a problem can be solved via the following steps:
determining a cost function describing the cost of execution of a/some particular task(s) as cost_function=ƒ(Clmax1, Clmax2, Time_{execution}); and
minimizing the cost function, bearing in mind that the first counter CImax1_{reg}, the second counter CImax2_{reg}, and the time of execution Time_{execution} depend, in a non-linear way, on the optimal clock divide factors N₁ₒₚₜ, . . . , Nₖₒₚₜ, and that inadmissible values for the (optimal) clock divide factors N₁ₒₚₜ, . . . , Nₖₒₚₜ due to clock constraints are discarded.

In various embodiments, the cost function may contain also other measurements that are available on the SOC.

The minimization of such a cost function may be performed using different minimization techniques, for instance, simulated annealing, tabu search, etc. Such techniques to find the minimum of a function are well-known in the art, and will not be described in detail herein to not overburden the present detailed description.

By way of example, the following steps may be applied in a minimization technique of the simulated annealing for computing optimal clock divide factors N₁ₒₚₜ, . . . , Nₖₒₚₜ in the solution disclosed herein:
first step: set in a random manner the values of the clock divide factors N₁, . . . , Nₖ in a specific set of registers of the sets of registers 272 which is a candidate to containing optimal clock divide factors N₁ₒₚₜ, . . . . Nₖₒₚₜ. Some of the randomly drawn values of the clock divide factors N₁, . . . , Nₖ may be rational numbers, but in any case, inadmissible values due to clock constraints are discarded;
second step: execute one or more tasks on the SOC device; and
third step: if the value of the cost function ƒ(CImax1, Clmax2, Time execution) is lower than the cost function in the previous iteration, the current values of the clock divide factors N₁, . . . , Nₖ are accepted as new values, otherwise they are accepted with a probability p, to avoid remaining in a local minimum of the cost function.

At the end of the third step, the process is repeated again from the first step, for instance after changing randomly a few of the clock divide factors N₁, . . . , Nₖ in the specific set of registers of the sets of registers 272, and the loop is repeated (even a large number of times such as a thousand times).

At the end of looping, the values stored in the specific set of registers of the sets of registers 272 which is expected to contain optimal clock divide factors N₁ₒₚₜ, . . . , Nₖₒₚₜ are optimal clock divide factors sought N₁ₒₚₜ, . . . , Nₖₒₚₜ. These optimal clock divide factors N₁ₒₚₜ, . . . , Nₖₒₚₜ are stored in a set of registers out of the sets of registers 272 at the end of the computation procedure. The values are “frozen” and used in the specific real scenario for what they were calculated.

Therefore, different sets of optimal clock divide factors N₁ₒₚₜ, . . . , Nₖₒₚₜ can be computed for different scenarios, for instance, by using different metrics or for different performance/battery life balances. Prior to starting a particular task related to one of such different scenarios, the corresponding optimal clock divide factors N₁ₒₚₜ, . . . , Nₖₒₚₜ for that scenario are used to replace the default ones.

Various embodiments may adopt different arrangements for storing the optimal clock divide factors N₁ₒₚₜ, . . . , Nₖₒₚₜ.

For instance, in various embodiments, the optimal clock divide factors N₁ₒₚₜ, . . . , Nₖₒₚₜ computed may be stored in a non-volatile memory, for instance, Flash, PCM, OTP, etc., and retrieved after each power cycle to be stored in a corresponding specific set of registers of the sets of registers 272.

In other embodiments, the optimal clock divide factors N₁ₒₚₜ, . . . , Nₖₒₚₜ computed may be retained in non-volatile registers. Such a solution may be used for instance, in flash-less products.

In still other embodiments, the optimal clock divide factors N₁ₒₚₜ, . . . , Nₖₒₚₜ, once first computed, can be re-calculated at each power cycle. Such a solution may be considered for instance, for devices that remain always on and that are switched off a few times a year.

Thus, the solution provided herein discloses a consumption detector, CD and a clock controller, CC with a set of clock division factors applied to modify consumption.

The consumption detector, CD uses two threshold registers to store two current thresholds, Imax1_{reg} and Imax2_{reg}, which are used as a comparison for an absorbed current. In response to these thresholds Imax1_{reg} and Imax2_{reg}, being exceeded a certain set of dividers of the clocks is selected and applied.

Division factors are calculated by a “smart” clock controller, SCC, that is circuit included in the clock controller, CC, circuitry in order to reduce the consumption by reducing a peripherals operating frequency. The “smart” clock controller, SCC may additionally comprise a learning procedure to determine the sets of (sub) optimal clock division factors for considered scenarios.

The solution as described herein facilitates achieving a balance between current consumption and performance, and in some embodiments, the balance between consumption and performance may be obtained to different degrees using different cost functions in learning procedures.

Thus, the solution as described herein enables the realization of long-life battery devices without downgrading their performance.

Without prejudice to the underlying principles, the details and the embodiments may vary, even significantly, with respect to what has been described by way of example only without departing from the scope of the embodiments.

The extent of protection is determined by the annexed claims.

1. A circuit comprising a plurality of peripherals configured to be clocked with respective clock signals, wherein the circuit comprises a clock controller configured to produce the respective clock signals via respective clock divide factors, the clock controller having stored therein respective sets of clock divide factors, wherein the clock controller comprises clock divide factor selection circuitry configured to select an operating set of clock divide factors out of the respective sets of clock divide factors and wherein the clock controller is configured to apply to the plurality of peripherals respective clock signals produced via the clock divide factors in the operating set of clock divide factors selected out of the respective sets of clock divide factors.

2. The circuit of claim 1, wherein the clock controller comprises a plurality of storage locations comprising a first storage location and a second storage location having stored therein a first set of clock divide factors and a second set of clock divide factors, respectively, wherein, in response to being clocked by respective clock signals produced via the second set of clock divide factors, the plurality of peripherals have a lower power absorption than when clocked by respective clock signals produced via the first set of clock divide factors.

3. The circuit of claim 2, wherein the clock divide factor selection circuitry in the clock controller is configured to receive a power status signal and to select the operating set of clock divide factors out of the first set and the second set of clock divide factors based on the power status signal.

4. The circuit of claim 3, comprising:
a consumption detector configured to monitor an amount of current absorbed by the circuit,
a power control logic unit configured to receive a current evaluation signal from the consumption detector and produce the power status signal based the current evaluation signal.

5. The circuit of claim 4, wherein the consumption detector is configured to have stored therein upper and lower threshold values for the current absorbed by the circuit, wherein the power control logic unit is configured to produce the power status signal based on a result of comparing the amount of current absorbed by the circuit with the upper and lower threshold values.

6. The circuit of claim 5, wherein the upper and lower threshold values are selectively adjustable.

7. The circuit of claim 5, wherein the consumption detector comprises counter circuitry configured to have count first and second counter values that are updated in response to the current absorbed by the circuit reaching the upper and lower threshold values respectively.

8. The circuit of claim 6, wherein the consumption detector comprises counter circuitry configured to have count first and second counter values that are updated in response to the current absorbed by the circuit reaching the upper and lower threshold values respectively.

9. The circuit of claim 1, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

10. The circuit of claim 2, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

11. The circuit of claim 3, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

12. The circuit of claim 4, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

13. The circuit of claim 5, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

14. The circuit of claim 6, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

15. The circuit of claim 7, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

16. The circuit of claim 8, wherein the circuit is configured to operate in a sequence of power cycles, and at least one set of clock divide factors in the sets of clock divide factors:
is stored in a non-volatile memory and loaded during a power cycle in the sequence of power cycles, or
is re-calculated during a power cycle in the sequence of power cycles.

17. A method of configuring the circuit of claim 1, wherein the method comprises the clock controller selecting a set of learning clock divide factors as a candidate operating set of clock divide factors, and
a) executing one or more tasks through the circuit with the plurality of peripherals clocked with respective clock signals produced via the set of learning clock divide factors,
b) checking circuit consumption and performance indicators in executing the one or more tasks against target consumption and performance specifications,
and
in response to the circuit consumption and performance indicators in executing the one or more tasks meeting the target consumption and performance specifications, selecting the learning clock divide factors as a configurated operating set of clock divide factors; or
in response to the circuit consumption and performance indicators in executing the one or more tasks failing to meet the target consumption and performance specifications repeating steps a) and b) with modified values for the set of learning clock divide factors.

18. The method of claim 17, wherein the circuit consumption and performance indicators in executing the one or more tasks comprise an execution cost defined via one of simulated annealing and tabu search.
